(19) United States
(12) Patent Application Publication
(10) Pub. No.: US 2009/0128496 A1
(43) Pub. Date: May 21, 2009

(54) Light-emitting keyboard

(76) Inventors: Chen-Hua Huang, Taipei (TW); Chang-Hung Pan, Taipei (TW); Ya-Tung I, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,409

(22) Filed: Feb. 21, 2008

(30) Foreign Application Priority Data
Nov. 15, 2007 (TW) 096143227

(51) Int. Cl. G06F 3/02

(52) U.S. Cl. 345/170

(57) ABSTRACT

A light-emitting keyboard includes a plurality of keys, a circuit switch module, and at least one light-emitting element. The circuit switch module is disposed below the keys and is depressible by the keys so as to transmit corresponding electrical signals. The circuit switch module includes at least one light-transmissive flexible circuit board. The flexible circuit board has a lower surface that is formed with at least one light reflecting point corresponding to a respective one of the keys. The light-emitting element is either disposed adjacent to a lateral edge of the flexible circuit board or embedded in the flexible circuit board to provide light into the flexible circuit board such that the light is propagated in the flexible circuit board and is scattered upward by the light-reflecting point.

### CROSS-REFERENCE TO RELATED APPLICATION

This application claims priority of Taiwanese Application No. 96143227, filed on Nov. 15, 2007.

### BACKGROUND OF THE INVENTION

1. Field of the Invention

The invention relates to a keyboard that serves as an input device of a computer, more particularly to a light-emitting keyboard that can emit light to assist a user to identify characters on keys of the keyboard.

2. Description of the Related Art

When using a computer or a mobile phone in a dim environment, it is often difficult to identify the characters or signs on keys of a keyboard used for inputting due to insufficient lighting.

To improve the aforesaid situation, a lighting module is generally provided below the keys of the keyboard, and a body portion of each key or a character/sign portion on the body portion is formed from a translucent material, such as the backlit key assembly disclosed in U.S. Pat. No. 6,743,993. Light emitted from the lighting module passes through the light-transmissive portions of the keys to help the user identify the characters and signs on the keys.

Moreover, for costs reasons, a light guide plate, such as that disclosed in U.S. Pat. No. 5,083,240, is generally used in a lighting module to guide and disperse light emitted from a light source, such as a light-emitting diode, to lower parts of the keys of a keyboard so that it would not be necessary to provide an individual light source beneath each key. This not only reduces the number of light sources required, the uniformity of light throughout the keyboard can also be enhanced.

However, how to further reduce the number of components in a keyboard with a lighting module in order to conform to the current trend for compactness and to address cost concerns has become a major subject of endeavor in the industry.

### SUMMARY OF THE INVENTION

In keeping with the current trend toward compactness and low costs, the present invention renounces the traditional concept of using a light guide to guide and disperse light, and proposes a light-emitting keyboard that utilizes one or all of light-transmissive circuit boards of a circuit switch module of the keyboard for light guiding and dispersal so as to illuminate the keys of the keyboard.

The circuit switch module is disposed below the keys of the keyboard, and can correspondingly transmit signals in response to depression of the keys. The circuit switch module is formed from at least one flexible circuit board. When one of the keys is depressed so as to contact a corresponding electrical contact on the flexible circuit board, the corresponding electrical contact is connected electrically so that a signal is transmitted.

If the circuit switch module is formed from one flexible circuit board, the flexible circuit board is configured to be a light-transmissive flexible circuit board.

If the circuit switch module is formed from two stacked flexible circuit boards, a partition plate is disposed between the two stacked flexible circuit boards, and the upper flexible circuit board is configured to be a light-transmissive circuit board or, alternatively, the two stacked flexible circuit boards and the partition plate are configured to be light-transmissive.

A light-emitting element provides light into the light-transmissive flexible circuit board. The light propagates within the flexible circuit board, and is scattered upward by light-reflecting points formed on a lower surface of the flexible circuit board.

Therefore, an object of the present invention is to provide a light-emitting keyboard that utilizes a light-transmissive circuit board to guide light propagation.

Another object of the present invention is to provide a light-emitting keyboard that can comply with the current trend toward compactness.

Accordingly, in one preferred embodiment, the light-emitting keyboard of this invention includes a plurality of keys, a circuit switch module, and at least one light-emitting element. Each of the keys has a body formed with a character/sign portion. The circuit switch module is disposed below the keys, and is depressible by the keys so as to correspondingly transmit electrical signals. The circuit switch module includes at least one light-transmissive flexible circuit board. The flexible circuit board has a lower surface formed with at least one light-reflecting point corresponding to a respective one of the keys. The light-emitting element is disposed in a housing, and is disposed adjacent to a lateral edge of the flexible circuit board or is embedded in the flexible circuit board to provide light into the flexible circuit board such that the light propagates in the flexible circuit board and is scattered upward by said at least one light reflecting point.

By having the light from the light-emitting element incident into the flexible circuit board for propagation therein, the present invention dispenses with the need to have a light guide for guiding and dispersing light as in the aforesaid conventional keyboard, thereby reducing the overall keyboard thickness and costs.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary exploded perspective view of the first preferred embodiment of a light-emitting keyboard according to the present invention;

FIG. 2 is a schematic sectional view of the first preferred embodiment;

FIG. 3 is a fragmentary exploded perspective view of the second preferred embodiment of a light-emitting keyboard according to the present invention; and

FIG. 4 is a schematic sectional view of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

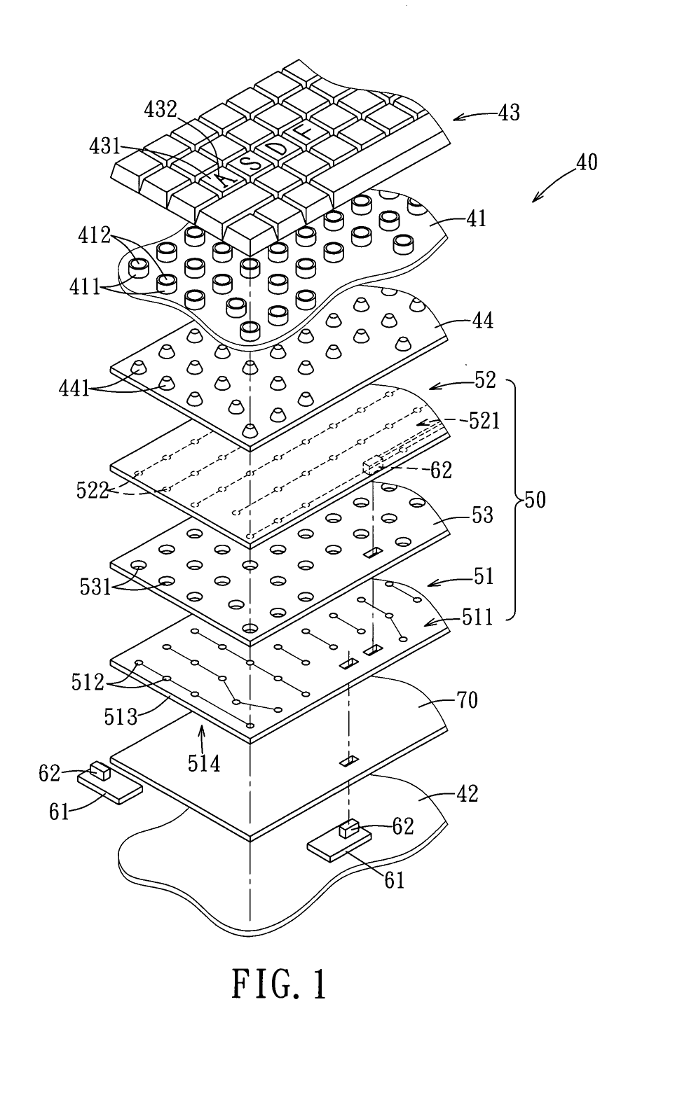

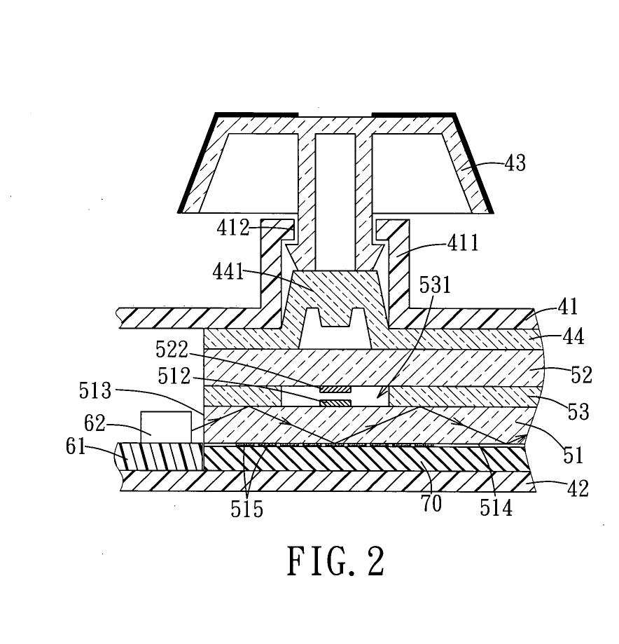

Referring to FIGS. 1 and 2, the first preferred embodiment of a light-emitting keyboard according to the present invention is shown to include a housing 40 having an upper housing half 41 and a lower housing half 42 that can be coupled to each other, a plurality of keys 43 disposed on top of the housing 40, a resilient pad 44 disposed in the housing 40, a circuit switch module 50 disposed in the housing 40 below the resilient pad 44, a light-reflecting plate 70 disposed in the housing 40 below the circuit switch module 50, and two light-emitting elements 62 disposed in the housing 40.

The upper housing half 41 has an upper surface formed with a plurality of positioning portions 411 projecting therefrom. Each positioning portion 411 is formed with a through hole 412.

Each key 43 has a body 431 formed with a character/sign portion 432. At least the character/sign portion 432 of the body 431 is formed from a light-transmissive material (e.g., a transparent or translucent material) for passage of light therethrough. Each key 43 extends movably downward into a respective one of the through holes 412, and has the character/sign portion 432 exposed upward.

The resilient pad 44 is formed from a light-transmissive and resilient material, such as silicone, and is formed with a plurality of posts 441 that extend respectively and upwardly into the through holes 412 formed respectively in the positioning portions 411 so as to respectively contact bottom portions of the keys 43.

The circuit switch module 50 includes a first flexible circuit board 51, a partition plate 53, and a second flexible circuit board 52 that are stacked one upon the other. In this embodiment, the first and second flexible circuit boards 51, 52 and the partition plate 53 are formed from a light-transmissive material, such as polycarbonate (PC) or polyethylene terephthalate (PET).

The first and second flexible circuit boards 51, 52 have confronting surfaces formed respectively with first and second conductive traces 511, 521 thereon. The first and second conductive traces 511, 521 are respectively formed with a plurality of first and second electrical contacts 512, 522. Each of the first electrical contacts 512 and each of the second electrical contacts 522 correspond to a respective one of the keys 43. The partition plate 53 is formed with a plurality of through holes 531 each of which corresponds to a respective one of the first electrical contacts 512 and a respective one of the second electrical contacts 522.

In use, when a force is applied to depress the key 43, the key 43 moves downward to depress the respective post 441, so that the post 441 moves downward to depress the second flexible circuit board 52 and cause a corresponding one of the second electrical contacts 522 to extend into the corresponding through hole 531 to contact a corresponding one of the first electrical contacts 512, thereby establishing an electrical connection so that a signal is transmitted.

In addition, a plurality of downwardly projecting minute light-reflecting points 515 are formed on a lower surface of the first flexible circuit board 51 by screen printing or hot pressing using ink, at positions corresponding to the keys 43, so that light can be refracted or scattered by the light-reflecting points 515.

The light-reflecting plate 70 is disposed below the first flexible circuit board 51 for reflecting the light upward so as to reduce downward light leakage to thereby enhance the light utilization rate.

Each of the light-emitting elements 62 is disposed on a circuit substrate board 61. In this embodiment, the light-emitting elements 62 are exemplified as light-emitting diodes, but are not limited thereto in practice. There are three ways of arranging the light-emitting elements 62 relative to the first flexible circuit board 51. One way is to dispose the light-emitting element 62 adjacent to a lateral edge 513 of the first flexible circuit board 51, such as the light-emitting element 62 on the left side of FIG. 1, so as to emit light into the first flexible circuit board 51 through the lateral edge 513. Another way is to insert the light-emitting element 62 upwardly into the first flexible circuit board 51 from a bottom surface 514 of the first flexible circuit board 51, such as the light-emitting element 62 on the lower housing half 42(see FIG. 1), so as to emit light into the first flexible circuit board 51 from within. One other way is to insert the light-emitting element 62 downwardly into the first flexible circuit board 51 from an upper surface of the first flexible circuit board 51, such as the light-emitting element 62 attached to a bottom surface of the second flexible circuit board 52 (see FIG. 1), so as to emit light into the first flexible circuit board 51 from within.

The present invention exploits the light-transmissive characteristic of the first flexible circuit board 51 to enable the light emitted from the light-emitting elements 62 to be incident into the first flexible circuit board 51 and, with the arrangement of the light-reflecting points 515 on the lower surface of the first flexible circuit board 51 and the light-reflecting plate 70 therebelow, the light emitted from the light-emitting elements 62 can be propagated through the first flexible circuit board 51 and further through the partition plate 53, the second flexible circuit board 52, the resilient pad 44, and the upper housing half 41 to escape through the light-transmissive portions of the keys 43.

In practice, the present invention is not limited to the aforesaid arrangement of having the light emitted from the light-emitting elements 62 incident into the first flexible circuit board 51 disposed at the lower portion of the circuit switch module 50 so as to utilize the first flexible circuit board 51 for light propagation. Since the second flexible circuit board 52 is also formed from a light-transmissive material, the light-emitting elements 62 can also be arranged adjacent to a lateral edge of the second flexible circuit board 52 or embedded in the second flexible circuit board 52 so that the light from the light-emitting elements 62 is incident into the second flexible circuit board 52 and propagates through the second flexible circuit board 52.

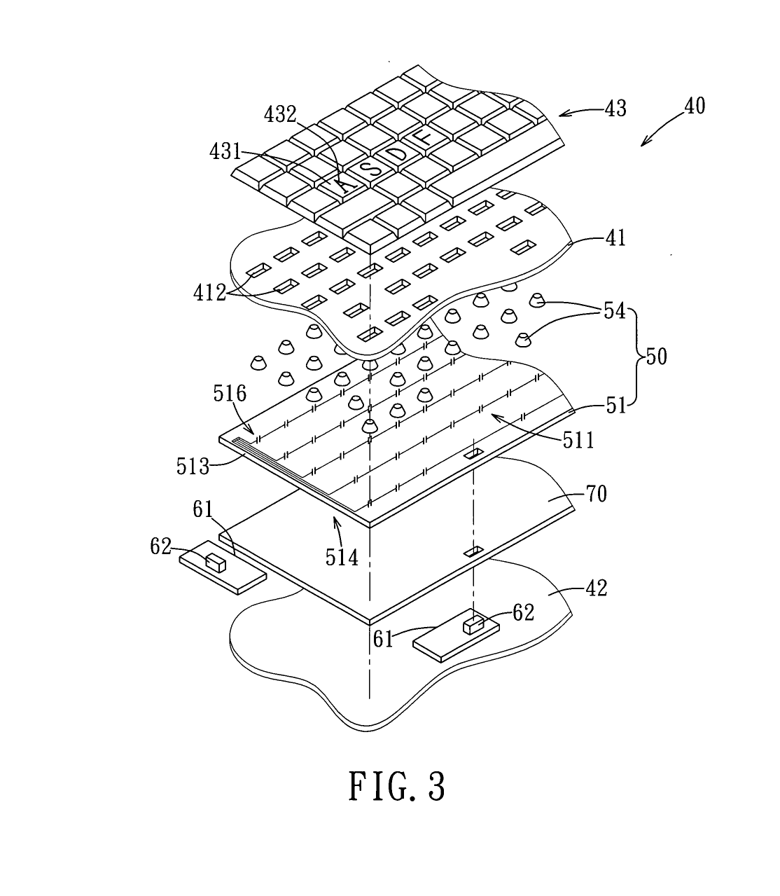

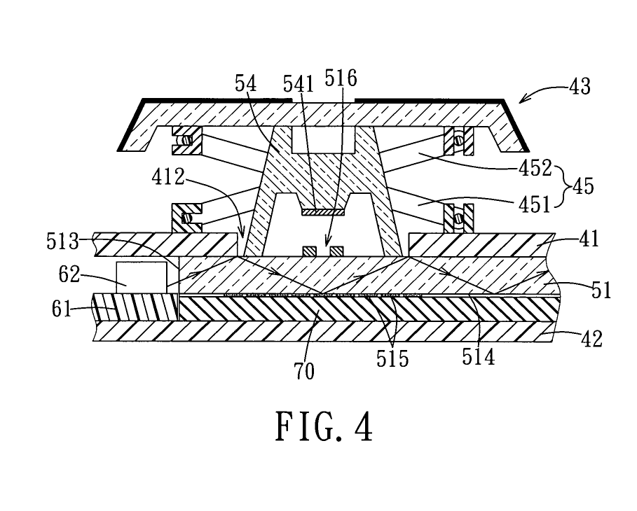

As shown in FIGS. 3 and 4, the second preferred embodiment of a light-emitting keyboard according to the present invention includes a housing 40 having an upper housing half 41 and a lower housing half 42 that can be coupled to each other, a plurality of keys 43, a plurality of scissors-like supports 45 (see FIG. 4), a circuit switch module 50 disposed below the keys 43, a light-reflecting plate 70 disposed in the housing 40 below the circuit switch module 50, and two light-emitting elements 62.

The upper housing half 41 is formed with a plurality of through holes 412.

Each of the keys 43 has a body 431 formed with a character/sign portion 432. At least the character/sign portion 432 of the body 431 is formed from a light-transmissive material (e.g., a transparent or translucent material) for passage of light therethrough. The character/sign portion 432 of each key 43 faces upward and is disposed above a corresponding one of the through holes 412.

The scissors-like supports 45 respectively straddle the through holes 412 in the upper housing half 41 to steadily support the respective keys 43 on the upper housing half 41. Each scissors-like support 45 includes two movable portions 451, 452, whose included angles are changeable to permit upward and downward movement of the respective key 43.

The circuit switch module 50 includes a flexible circuit board 51 disposed below the upper housing half 41, and a plurality of resilient posts 54 that extend respectively through the through holes 412 and that are disposed on the flexible circuit board 51.

The flexible circuit board 51 is formed from a light-transmissive material, such as polycarbonate (PC) or polyethylene terephthalate (PET), and has an upper surface formed with a plurality of conductive traces 511. Each conductive trace 511 is formed with circuit breaking points 516 at positions corresponding to the through holes 412. In addition, a plurality of minute light-reflecting points 515 are formed on a lower surface of the flexible circuit board 51 by screen printing or hot pressing using ink.

The resilient posts 54 are disposed at the circuit breaking points 516 on the flexible circuit board 51, and are formed from a light-transmissive and resilient material, such as silicone. Each resilient post 54 extends upward through the respective through hole 412 to support a respective one of the keys 43 so as to provide the respective key 43 with an upward restoring force when the respective key 43 is depressed. In addition, each resilient post 54 has a bottom portion provided with a conductive contact 541 corresponding to a respective one of the circuit breaking points 516.

In use, when a force is applied to depress one of the keys 43, the depressed key 43 moves downward to compress the respective resilient post 54 so that the conductive contact 541 on the bottom portion of the respective resilient post 54 comes into contact with the corresponding circuit breaking point 516 on the flexible circuit board 51 to thereby electrically connect the circuit breaking point 516, so that a signal is transmitted.

The light-reflecting plate 70 is disposed below the flexible circuit board 51 to reflect light toward the flexible circuit board 51 so as to reduce downward light leakage.

Each of the light-emitting elements 62 is disposed on a circuit substrate board 61. In this embodiment, the light-emitting elements 62 are exemplified as light-emitting diodes, but are not limited thereto in practice. There are two ways of arranging the light-emitting elements 62 relative to the flexible circuit board 51. One way is to dispose the light-emitting element 62 adjacent to a lateral edge 513 of the flexible circuit board 51, such as the light-emitting element 62 on the left side of FIG. 3, so as to emit light into the flexible circuit board 51 through the lateral edge 513. The other way is to insert the light-emitting element 62 upwardly into the flexible circuit board 51 from a bottom surface 514 of the flexible circuit board 51, such as the light-emitting element 62 on the right side of FIG. 3, so as to emit light into the flexible circuit board 51 from within.

The present invention exploits the light-transmissive characteristic of the flexible circuit board 51 to enable the light emitted from the light-emitting elements 62 to be incident into the flexible circuit board 51 so that light can be propagated within the flexible circuit board 51 to escape through the light-transmissive portions of the keys 43.

In sum, in the present invention, light from the light-emitting elements 62 are caused to be incident into at least one of the light-transmissive flexible circuit boards 51, 52, and the light-transmissive partition plate 53 so that the light can be propagated therein and reflected and scattered upward by the light-reflecting points 515 formed on the lower surface of the flexible circuit board 51, 52 or the partition plate 53, thereby permitting a reduction in the thickness of the light-emitting keyboard and costs.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A light-emitting keyboard comprising:
a plurality of keys;
a circuit switch module disposed below said keys and being depressible by said keys to establish an electrical connection so as to correspondingly transmit electrical signals, said circuit switch module including at least one light-transmissive flexible circuit board, said flexible circuit board having a lower surface that is formed with at least one light reflecting point corresponding to a respective one of said keys; and
at least one light-emitting element disposed to provide light into said flexible circuit board such that the light is propagated in said flexible circuit board and is scattered upward by said at least one light-reflecting point.

2. The light-emitting keyboard according to claim 1, wherein said light-emitting element is disposed adjacent to a lateral edge of said flexible circuit board.

3. The light-emitting keyboard according to claim 1, wherein said light-emitting element is embedded in said flexible circuit board.

4. The light-emitting keyboard according to claim 1, wherein each of said keys has a body formed with a character/sign portion, at least said character/sign portion of said body being light-transmissive.

5. The light-emitting keyboard according to claim 1, wherein said circuit switch module includes a first one of said flexible circuit boards, a light-transmissive partition plate, and a second one of said flexible circuit boards that are stacked one upon the other, the light from said light-emitting element being incident into a lower one of said flexible circuit boards.

6. The light-emitting keyboard according to claim 4, wherein said first and second ones of said flexible circuit boards have confronting surfaces that are respectively formed with a plurality of first and second conductive traces, said partition plate being formed with a plurality of through holes.

7. The light-emitting keyboard according to claim 1, wherein said circuit switch module further includes a plurality of resilient posts disposed on said flexible circuit board, said flexible circuit board being formed with a plurality of circuit breaking points, each of said resilient posts being provided with a conductive contact for connecting electrically to a corresponding one of said circuit breaking points.

8. The light-emitting keyboard according to claim 1, wherein said flexible circuit board is formed from one of polycarbonate and polyethylene terephthalate (PET).

9. The light-emitting keyboard according to claim 5, wherein said flexible circuit boards are formed from one of polycarbonate and polyethylene terephthalate (PET)

10. The light-emitting keyboard according to claim 6, wherein said flexible circuit boards are formed from one of polycarbonate and polyethylene terephthalate (PET).

11. The light-emitting keyboard according to claim 7, wherein said flexible circuit board is formed from one of polycarbonate and polyethylene terephthalate (PET).

12. The light-emitting keyboard according to claim 1, wherein said light-emitting element is a light-emitting diode.

13. The light-emitting keyboard according to claim 2, wherein said light-emitting element is a light-emitting diode.

14. The light-emitting keyboard according to claim 3, wherein said light-emitting element is a light-emitting diode.

15. The light-emitting keyboard according to claim 1, further comprising a light-reflecting plate disposed below said circuit switch module.

16. The light-emitting keyboard according to claim 2, further comprising a light-reflecting plate disposed below said circuit switch module.

17. The light-emitting keyboard according to claim 3, further comprising a light-reflecting plate disposed below said circuit switch module.

18. The light-emitting keyboard according to claim 5, further comprising a light-reflecting plate disposed below said circuit switch module.

19. The light-emitting keyboard according to claim 6, further comprising a light-reflecting plate disposed below said circuit switch module.

20. The light-emitting keyboard according to claim 7, further comprising a light-reflecting plate disposed below said circuit switch module.
